(19) United States
(12) Patent Application Publication
(10) Pub. No.: US 2017/0117625 A1
(43) Pub. Date: Apr. 27, 2017

(54) RADIO FREQUENCY CHOKES FOR INTEGRATED PHASED-ARRAY ANTENNAS

(71) Applicant: The Boeing Company, Chicago, IL (US)

(72) Inventors: David Lee Mohoric, Auburn, WA (US); Douglas Allan Pietila, Puyallup, WA (US); David N. Rasmussen, Seattle, WA (US); Robert T. Worl, Maple Valley, WA (US)

(21) Appl. No.: 14/923,929

(22) Filed: Oct. 27, 2015

(51) Int. Cl. H01Q 1/52; H01Q 21/00; H01Q 21/06

(52) U.S. Cl. CPC H01Q 1/525; H01Q 21/061; H01Q 21/0087

(57) ABSTRACT

Embodiments described herein provide for integrating a pair of phased-array antennas onto a common electrically-conductive plate, with groves fabricated into a top surface of the plate that operate as an RF choke. One embodiment comprises an apparatus that includes an electrically-conductive plate that has a top surface and an opposing bottom surface, a transmit phased-array antenna comprising a first plurality of holes through the plate from the top surface to the bottom surface that include RF transmit elements, and a receive phased-array antenna comprising a second plurality of holes through the plate from the top surface to the bottom surface that include RF receive elements. The apparatus further includes a plurality of grooves fabricated on the top surface of the plate that attenuate EM radiation induced on the receive phased-array antenna by the transmit phased-array antenna by a pre-defined amount.

### FIELD

This disclosure relates to the field of phased-array antennas, and in particular, to mitigating electromagnetic (EM) radiation effects that arises when multiple phased-array antennas are integrated together.

### BACKGROUND

Satellite communication systems may include both a receive antenna and a transmit antenna in order to provide bi-directional communication capabilities to a platform. The receive antenna and the transmit antenna are separated from each other to prevent the receive antenna from being overwhelmed by the EM transmissions generated by the transmit antenna. The antennas are also located along a portion of the platform that has a direct line of sight to the satellite(s).

However, providing a separation between the receive antenna and the transmit antenna can be difficult when the physical real estate onboard the platform for the antennas is limited. For instance, on a small aircraft such as a drone, the antennas would ideally be located along a top surface of the fuselage of the drone at a sufficient separation from each other in order to preclude the transmit antenna from generating Radio Frequency (RF) interference at the receive antenna. Yet, there may not be enough physical area on the fuselage to provide such separation. Further, utilizing multiple antennas, even when they are sufficiently separated from each other, involves the use of two separate enclosures that are each subjected to the environment and therefore, provide the possibility of multiple points of failure for the communication system. Further still, there is an ongoing desire to provide bi-directional communication systems that are of a light weight and compact design.

### SUMMARY

Embodiments described herein provide for integrating a pair of phased-array antennas onto a common electrically-conductive plate, with groves fabricated into a top surface of the plate that operate as an RF choke. The RF choke providing an attenuation of the EM radiation induced on a receive antenna formed on the plate by a transmit antenna formed on the plate

One embodiment comprises an apparatus that includes an electrically-conductive plate that has a top surface and an opposing bottom surface, a transmit phased-array antenna comprising a first plurality of holes through the plate from the top surface to the bottom surface that include RF transmit elements, and a receive phased-array antenna comprising a second plurality of holes through the plate from the top surface to the bottom surface that include RF receive elements. The apparatus further includes a plurality of grooves fabricated on the top surface of the plate that attenuate EM radiation induced on the receive phased-array antenna by the transmit phased-array antenna by a pre-defined amount.

Another embodiment comprises a method of fabricating a pair of phased-array antennas that are integrated on a common electrically-conductive plate. The method comprises forming a transmit phased-array antenna utilizing a first plurality of holes through an electrically-conductive plate that include RF transmit elements. The method further comprises forming a receive phased-array antenna utilizing a second plurality of holes through the plate that include RF receive elements. The method further comprises fabricating a plurality of grooves on a top surface of the plate that attenuate EM radiation induced on the receive phased-array antenna by the transmit phased-array antenna by a pre-defined amount.

Another embodiment comprises an apparatus that includes an electrically-conductive aperture plate that has a top surface, a first antenna aperture formed from a first plurality of holes through the aperture plate, and a second antenna aperture formed from a second plurality of holes through the aperture plate. The apparatus further comprises a plurality of grooves fabricated on the top surface of the aperture plate that are configured to attenuate EM radiation induced on a receive antenna formed from the first antenna aperture by a transmit antenna formed from the second antenna aperture by a pre-defined amount.

The above summary provides a basic understanding of some aspects of the specification. This summary is not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments are now described, by way of example only, and with reference to the accompanying drawings. The same reference number represents the same element or the same type of element on all drawings.

FIG. 1 illustrates an airborne mobile platform having an antenna device that integrates a pair of phased-array antennas in an exemplary embodiment.

FIG. 2 illustrates an isometric view of the antenna device of FIG. 1 in an exemplary embodiment.

FIG. 3 illustrates a cross-sectional view of a plate of the antenna device of FIG. 2 is in an exemplary embodiment.

FIGS. 4-5 illustrate a cross-sectional view of the plate of FIG. 3 with grooves having a variable depth in an exemplary embodiment.

FIG. 6 illustrates a cross-sectional view of the plate of FIG. 3 with groves that include a dielectric material in an exemplary embodiment.

FIG. 7 illustrates an isometric view of the antenna device of FIG. 2 with grooves that partially circumscribe a receive phased-array antenna and a transmit phased-array antenna in an exemplary embodiment.

FIGS. 8-10 illustrate flow charts of a method of fabricating an antenna device that integrates a pair of phased-array antennas in an exemplary embodiment.

FIG. 11 illustrates an isometric view of an aperture plate in an exemplary embodiment.

FIG. 12 illustrates a cross-sectional view of a portion of the aperture plate of FIG. 11 in an exemplary embodiment.

### DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

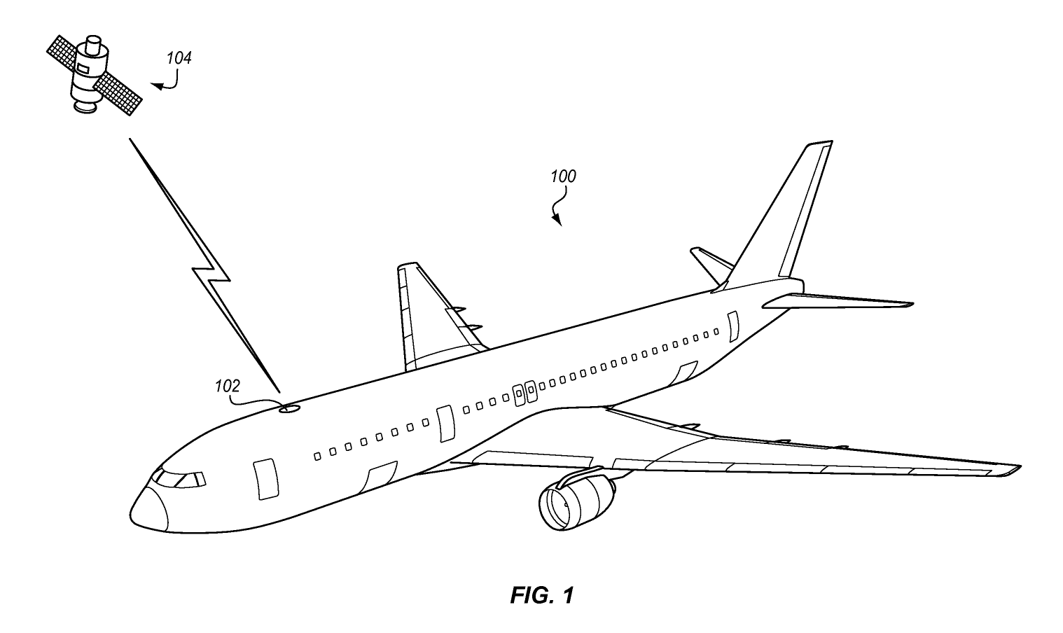

FIG. 1 illustrates an airborne mobile platform 100 having an antenna device 102 that integrates a pair of phased-array antennas in an exemplary embodiment. In this embodiment, mobile platform 100 is an aircraft having a particular configuration, although in other embodiments mobile platform 100 may include other aircraft, both manned and unmanned, having different configurations as desired. Mobile platform 100 may include drones, missiles, vehicles, stationary communication installations, etc., as desired. Thus, the particular illustration with respect to mobile platform 100 in FIG. 1 is merely for purposes of discussion.

In this embodiment, mobile platform 100 communicates with one or more satellites 104 using an antenna device 102, although in other embodiments antenna device 102 may be used to communicate with other entities that utilize Common Data Link (CDL) protocols. In this embodiment, antenna device 102 provides a bi-directional communication link between mobile platform 100 and satellite(s) 104. For example, antenna device 102 may communicate with satellite(s) 104 to provide high speed bi-directional data services to mobile platform 100 over the Ka-band, which covers frequencies from 26.5 GHz to 40 GHz. One example of a Ka-band data service that may be provided by satellite(s) 104 includes the Inmarsat Global Xpress (GX) program.

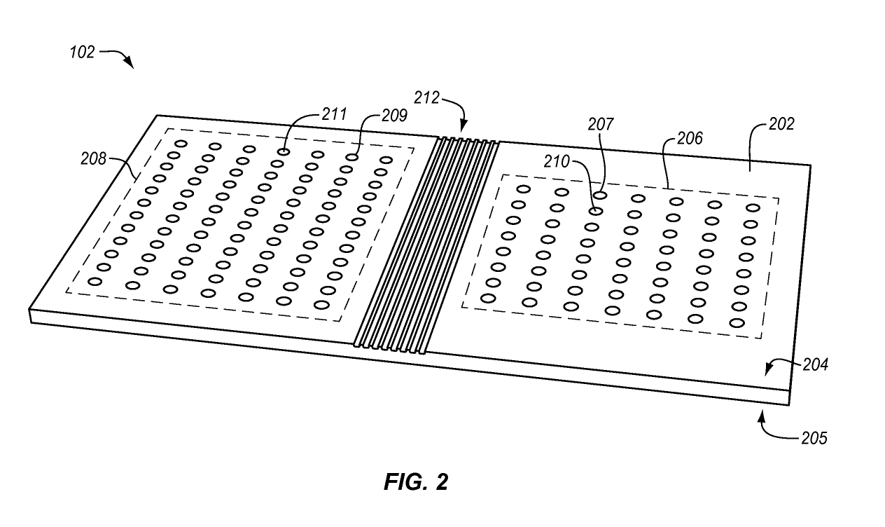

FIG. 2 illustrates an isometric view of antenna device 102 in an exemplary embodiment. In this embodiment, antenna device 102 includes a transmit phased-array antenna 206 and a receive phased-array antenna 208 that are both fabricated together on an electrically-conductive plate 202. Transmit antenna 206 is formed from a first plurality of holes 207 that traverse through plate 202 between a top surface 204 and a bottom surface 205. Holes 207 include RF transmit elements 210 that are used to generate RF signals.

Receive antenna 208 is formed from a second plurality of holes 209 that are disposed away from holes 207, and traverse through plate 202 between top surface 204 and bottom surface 205. Holes 209 include RF receive elements 211 that are used to receive RF signals.

Plate 202 may be referred to as an aperture plate in some embodiments. One example of the material that plate 202 may be formed from is aluminum, although plate 202 may be formed from any material that is electrically-conductive as desired.

In this embodiment, plate 202 is illustrated having surfaces 204-205 that are planar, although in other embodiments, surfaces 204-205 may be include non-planar features that allow antenna device 202 to conform to an outer surface of mobile platform 100.

Plate 202 includes a plurality of grooves 212 on top surface 204. Grooves 212 operate as an RF choke to attenuate EM radiation induced upon receive antenna 208 when transmit antenna 206 is operating (e.g., when RF transmit elements 210 are generating RF signals). Grooves 212 are located between transmit antenna 206 and receive antenna 208, and traverse across plate 202.

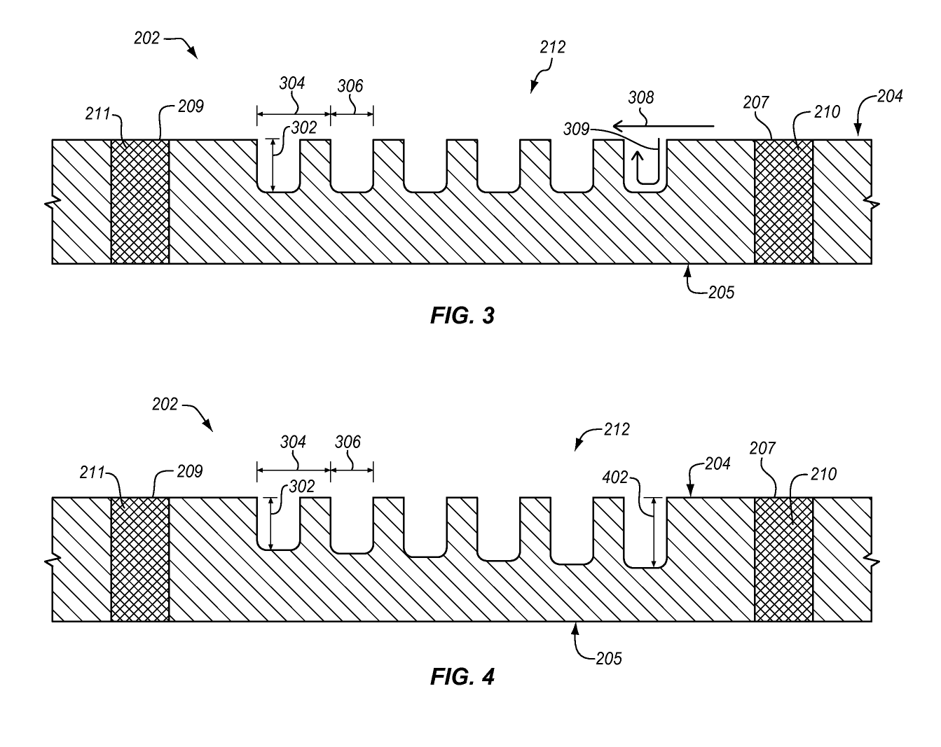

FIG. 3 illustrates a cross-sectional view of plate 202 in an exemplary embodiment. In this embodiment, grooves 212 have depth 302 that is about ¼ of a wavelength of an operating frequency of transmit antenna 206. For example, if transmit antenna 206 operates in the GX uplink band of 30 GHz, then depth 302 may be about 0.0984 inches. But, since the operating frequency of transmit antenna 206 may include any frequency as a matter of design choice, depth 302 may be different at other operating frequencies. The Ka-band lies between 26.5-40 GHz, so depth 302 may be between 0.1114 inches and 0.0738 inches if transmit antenna 206 operates within the Ka-band.

Grooves 212 in this embodiment are spaced apart, and have a period 304 and a width 306. Period 304, width 306, and/or depth 302 may be selected to provide a desired RF attenuation performance of grooves 212.

During RF transmissions, transmit antenna 206 has the potential to induce EM radiation on receive antenna 208 due to the close proximity of receive antenna 208 to transmit antenna 206. During RF transmission, RF transmit elements 210 within transmit antenna 206 induce a surface current 308 at plate 202, which can interfere with the RF performance of RF receive elements 211 within receive antenna 208. Grooves 212 operate as an RF choke by cancelling out a portion of surface current 308. Grooves 212 present a different path length to a current 309 that travels within grooves 212, and a 180 degree phase shift is imparted onto current 309. When surface current 308 and current 309 re-combine, a portion of surface current 308 is cancelled by current 309. The amount of attenuation of surface current 308 can be controlled based on the number of grooves 212 that are included on top surface 204 of plate 202.

The distance that current 309 takes through grooves 212 is based on the surface path length within each of grooves 212, so the performance of grooves 212 as an RF choke is sensitive to the center frequency of transmit antenna 206. The performance of grooves 212 as an RF choke can be improved by varying depth 302 for grooves 212.

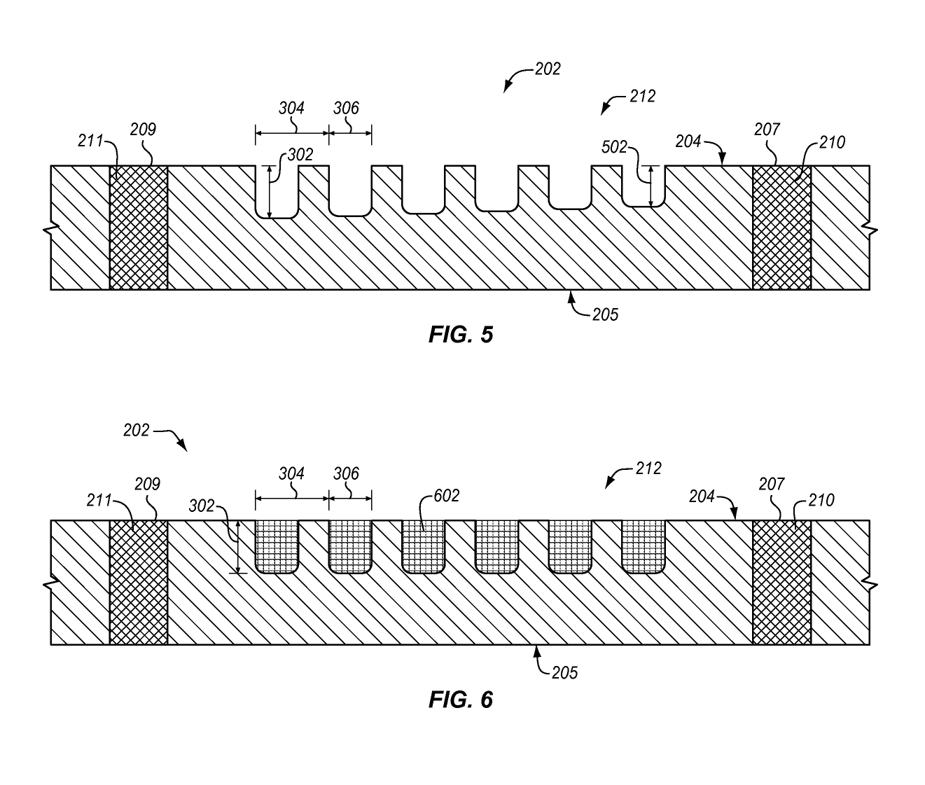

FIGS. 4-5 illustrate a cross-sectional view of plate 202 with grooves 212 having a variable depth in an exemplary embodiment. In FIG. 4, grooves 212 vary from depth 302 to a larger depth 402 from left to right. For instance, grooves 212 may vary from depth 302, which may be about ¼ of a wavelength of an operating frequency of transmit antenna 206, to depth 402, which is more than ¼ of a wavelength of an operating frequency of transmit antenna 206. As the path length increases for grooves 212, the frequency that is attenuated by grooves 212 is lower. Therefore, varying a depth of grooves 212 as per FIG. 4 improves the capability of grooves 212 to attenuate frequencies at the operating frequency of transmit antenna 206 and slightly below the operating frequency of transmit antenna 206.

In FIG. 5, grooves 212 vary from depth 302 to a smaller depth 502 from left to right. For instance, grooves 212 may vary from depth 302, which may be about ¼ of a wavelength of an operating frequency of transmit antenna 206, to depth 502, which is less than ¼ of a wavelength of an operating frequency of transmit antenna 206. As the path decreases for grooves 212, the frequency that is attenuated by grooves 212 is higher. Therefore, varying a depth of grooves 212 as per FIG. 5 improves the capability of grooves 212 to attenuate frequencies at the operating frequency of transmit antenna 206 and slightly above the operating frequency of transmit antenna 206. Varying the depth of grooves 212 both below and above ¼ of the wavelength of the center frequency of transmit antenna 206 may allow for both carrier attenuation and attenuation for the broadband signal applied to the carrier, further improving the performance of grooves 212 as an RF choke in antenna device 102. Varying the depth of grooves 212 allows an RF designer to effectively “tune” the carrier and/or broadband attenuation to minimize the RF impact on receive antenna 208.

FIG. 6 illustrates a cross-sectional view of plate 202 with groves 212 that include a dielectric material 602. In some embodiment, it may be desirable to fill grooves 212 with dielectric material 602, which prevents material from collecting in grooves 212 after fabrication. Dielectric material 602 is co-planar with top surface 204, and may comprise BMS5-95. In the Ka-band, BMS5-95 has a dielectric constant (Er) of about 3.93.

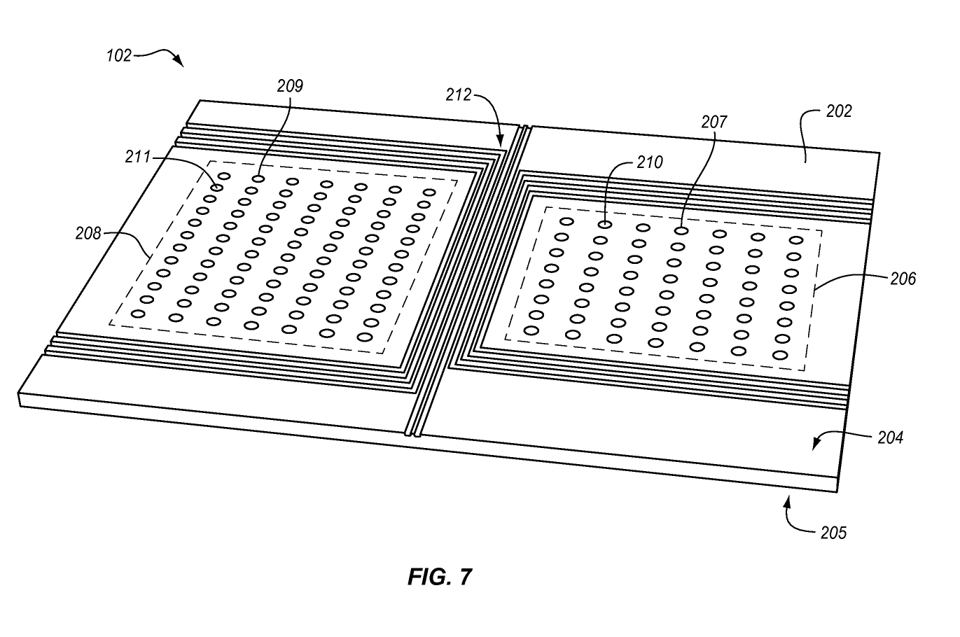

FIG. 7 illustrates an isometric view of antenna device 102 with grooves 212 that partially circumscribe transmit antenna 206 and receive antenna 208 in an exemplary embodiment. In some cases, it may be desirable to fabricate grooves 212 to partially circumscribe transmit antenna 206 and/or receive antenna 208. For instance, partially circumscribing transmit antenna 206 with grooves 212 may prevent the operation of transmit antenna 206 from inducing EM radiation onto other electronic systems onboard mobile platform 100. In like manner, partially circumscribing receive antenna 208 with grooves 212 may prevent other electronic systems onboard mobile platform 100 (e.g., systems other than transmit antenna 206) from inducing EM radiation onto receive antenna 208. In other embodiments, grooves 212 may fully circumscribe transmit antenna 206 and/or receive antenna 208.

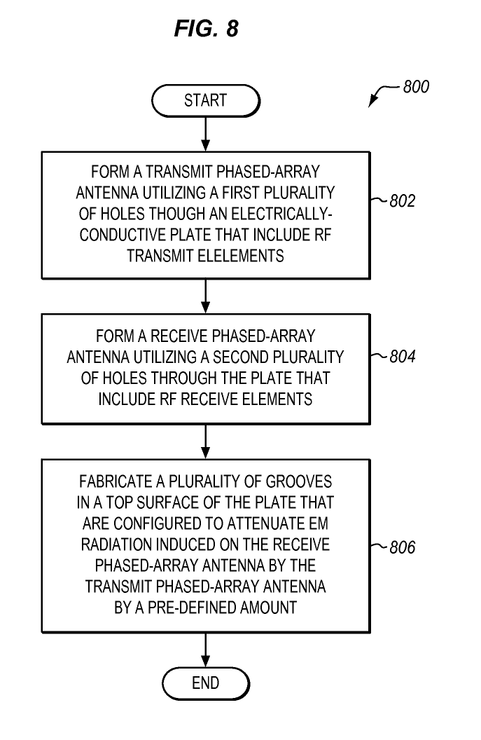

FIGS. 8-10 illustrate flow charts of a method 800 of fabricating an antenna device that integrates a pair of phased-array antennas in an exemplary embodiment. The steps of method 800 will be discussed with respect to antenna device 102, although method 800 may apply to other integrated phased-array antennas not shown. Method 800 may include other steps not shown, and the steps may be performed in an alternate order.

Prior to the actual fabrication of an integrated pair of phased-array antennas, an RF designer starts with a number of design parameters that constrain some of the physical parameters of an integrated phased-array antenna. For instance, the physical size of the antenna device may be limited on smaller mobile platforms, the number of grooves in the plate may be constrained by the available surface area that may be used as an RF choke, the aperture sizes of the transmit and/or the receive antenna may have both RF constraints and physical constraints. From an RF perspective, the aperture size of the transmit antenna may have a lower limit based on the effective radiated power of the transmit antenna, the sensitivity of the intended receiver of the transmit antenna, etc. The aperture size of the receive antenna may have a lower limit based on a corresponding RF sensitivity of the receive antenna, the transmit power of the RF source for the receive antenna, etc.

To fabricate antenna device 102 (see FIG. 2), transmit phased array antenna 206 is formed utilizing holes 207 through plate 202 that include RF transmit elements 210 (see step 802 of FIG. 8). Holes 207 are typically periodic across transmit antenna 206, and have a particular number, width, and spacing that is based on the desired RF performance of transmit antenna 206. Receive phased array antenna 208 is formed utilizing holes 209 through plate 202 that include RF receive elements 211 (see step 804 of FIG. 8). Holes 209 are typically periodic across receive antenna 208, and have a particular number, width, and spacing that is based on the desired RF performance of receive antenna 208. A diameter and spacing of holes 207 and holes 209 may be inversely proportional to an operating frequency of transmit antenna 206 and receive antenna 208, respectively. The spacing is typically ½ the wavelength of the operating frequency.

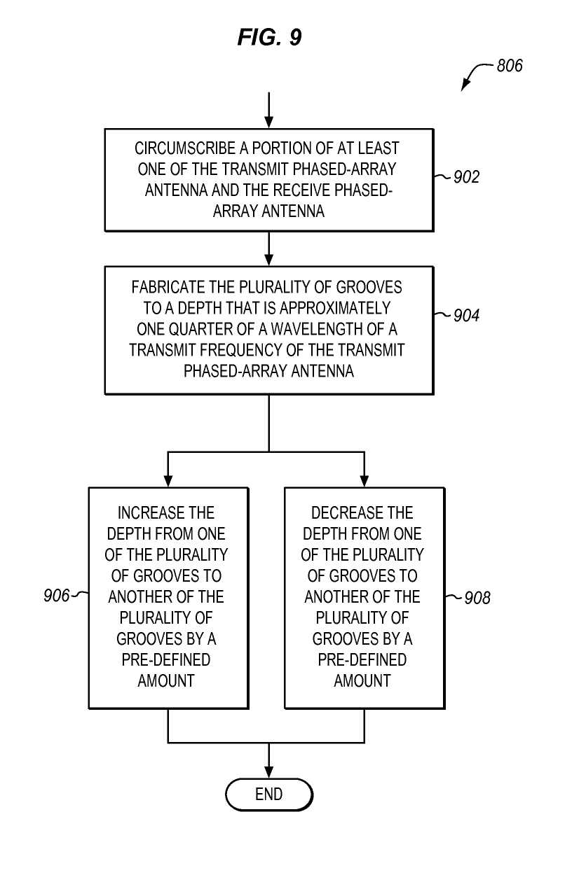

To fabricate the RF choke for antenna device 102, grooves 212 are fabricated on top surface 204 of plate 202 (see FIG. 3). Grooves 212 have a particular set of periodic features (depth, width, and spacing) that are selected to attenuate the EM radiation induced on receive antenna 208 from transmit antenna 206 by a pre-defined amount (see step 806). The particular depth, spacing, and number of grooves 212 depends upon the desired RF performance of grooves 212 as an RF choke, with these periodic features designed to introduce an out-of-phase current (e.g., current 309) at plate 202 to cancel out the surface currents (e.g., surface current 308) induced into plate 202 by transmit antenna 206. The operating frequency of transmit antenna 206 is the main design consideration, with the depth (e.g., depth 302) of grooves 212 being about ¼ of the wavelength of the operating frequency of transmit antenna 206 (see step 904 of FIG. 9).

The particular placement of grooves 212 on plate 202 is subject to design considerations, with some options including circumscribing transmit antenna 206 and/or receive antenna 208 (see step 902 of FIG. 9) illustrated previously for FIG. 7.

As discussed previously, the depth may vary around the idealized ¼ wavelength to attenuate frequencies slightly above and/or below the operating frequencies. For example, the depth may increase (see step 906 of FIG. 9) as illustrated in FIG. 4 (e.g., depth 402 is larger than depth 302), or the depth may decrease (see step 908 of FIG. 9) as illustrated in FIG. 5 (e.g., depth 302 is less than depth 502).

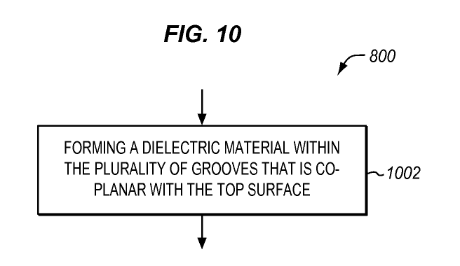

Other fabrication steps for antenna device 102 may include forming dielectric material 602 in grooves 212 (see step 1002 of FIG. 10), as illustrated in FIG. 6.

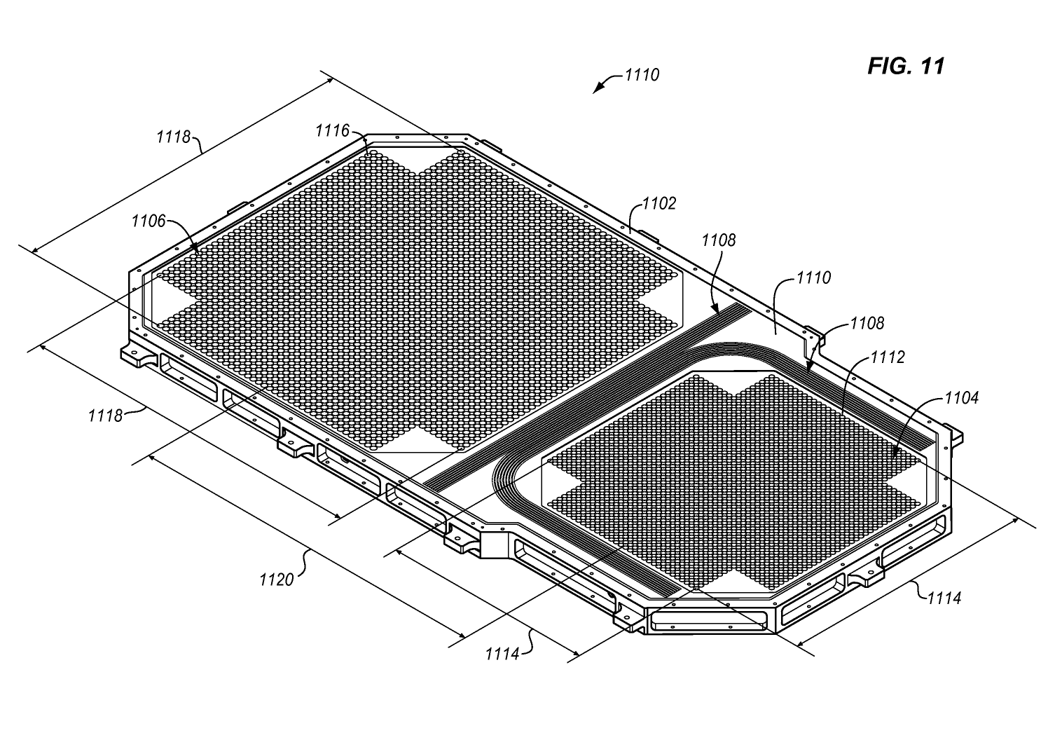

FIG. 11 illustrates an isometric view of an aperture plate 1000 in an exemplary embodiment. In this embodiment, aperture plate 1000 comprises an electrically non-conductive material 1102 (e.g., aluminum) and includes a transmit phased-array antenna aperture 1104, a receive phased-array antenna aperture 1106, and a plurality of grooves 1108 fabricated into a top surface 1110. Grooves 1108 are located between transmit antenna aperture 1104 and receive antenna aperture 1106, and partially circumscribe transmit antenna aperture 1104.

In this embodiment, transmit antenna aperture 1104 comprises 2048 separate holes 1112, forming an area that is 17.625 inches by 17.625 inches on each side 1114. The designed frequency of a transmit phased-array antenna formed from transmit antenna aperture 1104 (e.g., utilizing active RF elements within holes 1112) is 14 GHz to 14.5 GHz in this embodiment.

Receive antenna aperture 1106 comprises 2880 separate holes 1116, forming an area that is 23.925 inches by 23.925 inches on each side 1118. The designed frequency of a receive phased-array antenna formed from receive antenna aperture 1106 (e.g., utilizing passive RF elements within holes 1116) is 10.7 GHz to 12.75 GHz. A center of transmit antenna aperture 1104 and a center of receive antenna aperture 1106 are separated by a distance 1120 in this embodiment that is 25.23 inches.

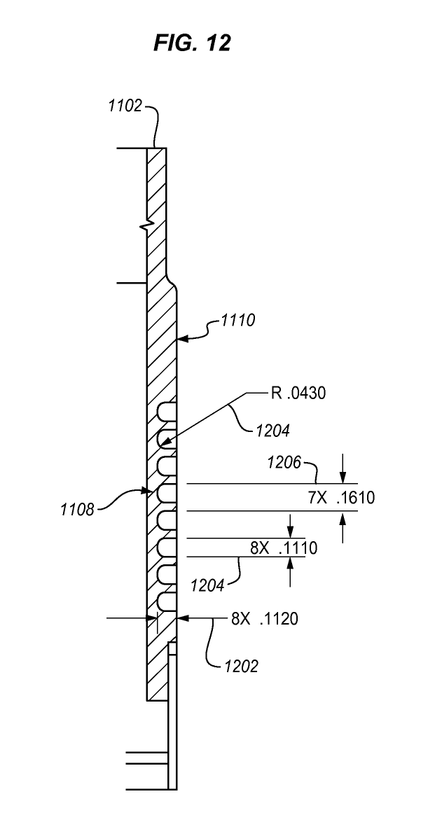

FIG. 12 illustrates a cross-sectional view of aperture plate 1000 in an exemplary embodiment. In this embodiment, there are 8 grooves 1108 that have a depth 1202 of 0.1120 inches into top surface 1110, a width 1204 of 0.1110 inches, and have a period 1206 of 0.1610 inches. The 8 groove design is expected to provide about 35 dB of isolation between a transmit antenna formed from transmit antenna aperture 1104 and a receive antenna formed from receive antenna aperture 1106 at a scan angle of about 68.75 degrees.

Utilizing the embodiments described herein allows for the integration of both transmit phased-array and receive phased-array antennas together on the same electrically-conductive plate, which eliminates the use of two separate enclosures that house separate antenna assemblies. Further, the embodiments described herein provide bi-directional communication systems that are of a light weight and compact design.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope is not limited to those specific embodiments. Rather, the scope is defined by the following claims and any equivalents thereof.

1. An apparatus comprising:
an electrically-conductive plate having a top surface and an opposing bottom surface;
a transmit phased-array antenna comprising a first plurality of holes through the plate from the top surface to the bottom surface that include Radio Frequency (RF) transmit elements;
a receive phased-array antenna comprising a second plurality of holes through the plate from the top surface to the bottom surface that include RF receive elements; and
a plurality of grooves on the top surface of the plate that are configured to attenuate electromagnetic radiation induced on the receive phased-array antenna by the transmit phased-array antenna by a pre-defined amount.

2. The apparatus of claim 1 wherein:
the plurality of grooves circumscribe a portion of at least one of the transmit phased-array antenna and the receive phased-array antenna.

3. The apparatus of claim 1 wherein:
the plurality of grooves have a depth of approximately one quarter of a wavelength of a transmit frequency of the transmit phased-array antenna.

4. The apparatus of claim 3 wherein:
the depth increases from one of the plurality of grooves to another of the plurality of grooves by a pre-defined amount.

5. The apparatus of claim 3 wherein:
the depth decreases across the plurality of grooves by a pre-defined amount.

6. The apparatus of claim 1 wherein:
the plurality of grooves are parallel to each other.

7. The apparatus of claim 1 further comprising:
a dielectric material formed within the plurality of grooves that is co-planar with the top surface.

8. A method comprising:
forming a transmit phased-array antenna utilizing a first plurality of holes through an electrically-conductive plate that include Radio Frequency (RF) transmit elements;
forming a receive phased-array antenna utilizing a second plurality of holes through the plate that include RF receive elements; and
fabricating a plurality of grooves on a top surface of the plate that are configured to attenuate electromagnetic radiation induced on the receive phased-array antenna by the transmit phased-array antenna by a pre-defined amount.

9. The method of claim 8 wherein fabricating the plurality of grooves further comprises:
circumscribing a portion of at least one of the transmit phased-array antenna and the receive phased-array antenna.

10. The method of claim 8 wherein fabricating the plurality of grooves further comprises:
fabricating the plurality of grooves to a depth that is approximately one quarter of a wavelength of a transmit frequency of the transmit phased-array antenna.

11. The method of claim 10 wherein fabricating the plurality of grooves further comprises:
increasing the depth from one of the plurality of grooves to another of the plurality of grooves by a pre-defined amount.

12. The method of claim 10 wherein fabricating the plurality of grooves further comprises:
decreasing the depth from one of the plurality of grooves to another of the plurality of grooves by a pre-defined amount.

13. The method of claim 8 further comprising:
forming a dielectric material within the plurality of grooves that is co-planar with the top surface.

14. An apparatus comprising:
an electrically-conductive aperture plate having a top surface;
a first antenna aperture formed from a first plurality of holes through the aperture plate;
a second antenna aperture formed from a second plurality of holes through the aperture plate; and
a plurality of grooves on the top surface of the plate that are configured to attenuate electromagnetic radiation induced on a receive phased-array antenna formed from the first antenna aperture the by a transmit phased-array antenna formed from the second antenna aperture by a pre-defined amount.

15. The apparatus of claim 14 wherein:
the plurality of grooves circumscribe a portion of at least one of the first antenna aperture and the second antenna aperture.

16. The apparatus of claim 14 wherein:
the plurality of grooves have a depth of approximately one quarter of a wavelength of a transmit frequency of the transmit phased-array antenna.

17. The apparatus of claim 16 wherein:
the depth increases from one of the plurality of grooves to another of the plurality of grooves by a pre-defined amount.

18. The apparatus of claim 16 wherein:
the depth decreases across the plurality of grooves by a pre-defined amount.

19. The apparatus of claim 14 wherein:
the plurality of grooves are parallel to each other.

20. The apparatus of claim 14 further comprising:
a dielectric material formed within the plurality of grooves that is co-planar with the top surface.
